(19) United States
(12) Patent Application Publication
(10) Pub. No.: US 2006/0141123 A1
(43) Pub. Date: Jun. 29, 2006

(54) Process for treating meat

(76) Inventor: Erik Magistad Berge, Oslo (NO)

Correspondence Address: SCHNECK & SCHNECK, P.O. BOX 2-E, SAN JOSE, CA, 95109-0005, US

(21) Appl. No.: 10/546,413

(22) PCT Filed: Dec. 10, 2003
(86) PCT No.: PCT/NO03/00412

§ 371 Date: Oct. 18, 2005

(30) Foreign Application Priority Data
Feb. 19, 2003 (NO) 20030788
Jan. 30, 2003 (NO) 20033003

(51) Int. Cl. A23L 1/31

(52) U.S. Cl. 426/641

(57) ABSTRACT

Process for producing a treated meat product for storage or consumption. The meat is treated with sugar in the form of granules or powder. Then the meat is placed in an airtight container which is evacuated. The negative pressure is in the interval of 330-530 bar. The container is stored at a temperature above 0° C. for 7 days or more. During the storage a fermentation process takes place. A consumable meat product with improved organoleptic properties is formed.

The present invention concerns a process for post-treatment of meat that has been pre-treated with a composition comprising a sugar in the form of a powder, grains, a granulate or a solution. The post-treatment according to the invention produces a product with improved nutritional value through removal of fat and thereby making it leaner, providing a product wherein the contents of harmful components such as environmental pollutants and toxins have been reduced during pre-treatment, and that during the continued post-treatment according to the invention, becomes partially fermented through a process that is performed under vacuum. With regards to the expression “meat”, this is to be understood in relation to the present invention to include all kinds of meat from land-dwelling animals (bovines, porcines, ovines, etc.), as well as water-dwelling animals (fish, crustaceans, shellfish etc.). It is preferred that the meat is derived from cattle, horses, small farm animals, swine, game (elk, reindeer, deer, etc.), birds (turkey, chicken, grouse, capercaillie, etc.) or fish (herring, salmon, trout, halibut, cod, etc.). The process according to the invention is particularly suited for treating fresh-water fish, salt-water fish, shrimps, roe and milt.

The pre-treatment of the meat being post-treated according to the invention, produced an increase of the proportion of solids (the proportion of dry matter) in the meat and a decrease of the proportion of organic acids and water-soluble acids being leached via the sugar treatment, and wherein the microbiological purity of the meat is simultaneously maintained by there not being supplied additional microbes through the pre-treatment with sugar. Such pre-treatment comprises that the meat, either in fresh, pre-treated (e.g. irradiated) or stored (frozen/thawed) condition, is brought into contact with sugar, preferably in the form of a powder, whereby an exudate is formed (extract). This exudate represents an aqueous extract from the meat wherein heavy metals, toxins, degenerative products etc. that largely represent waste products, are extracted. Such waste products may also form subsequent to the slaughtering of animals wherein the slaughtermeat is the subject of several organic and biochemical reactions, e.g. the production of acids through the intervention of rigor mortis, while the quality of the meat will simultaneously depend on the condition of the slaughtered animal prior to slaughtering (stress, feed, exercise, etc.). Such reactions may produce an inferior flavour, smell or consistency of the meat. The sugar treatment mentioned above will remove all or a part of such waste products, in addition to said toxins and heavy metals being present in the exudate from the meat subsequent to the treatment. This exudate is discarded. A specific sugar treatment of the meat with saccharose per se is known and the treatment time and treatment conditions with this sugar is known to the person skilled in the art. In this regard reference is made to U.S. Pat. No. 5.607.713. A possible time range for sugar treatment of the type of meat and meat products mentioned above, will be from 6 hours and above, e.g. for a time in the range of 6 hours to 100 hours, preferably about 24 hours. The sugar is added to the said meat in excess.

In the context of the present invention the term “sugar” is to include saccharides such as mono-, di- or polysaccharides, e.g. sucrose, fructose, mannose, maltose, glucose etc. Preferred are mono- or disaccharides, and particularly sucrose, maltose or fructose.

The advantage of pre-treating the meat with sugar is that a reproducible process is thereby employed that does not deteriorate the structure of the meat, and that does not change the organoleptic properties of the meat (e.g. flavour and smell) since the exudate contains large quantities of the sugar being used. Additionally, flesh from fish with coloured flesh (salmon, trout) will actually enhance its red colour somewhat through the sugar treatment, something which is advantageous since the meat will then appear more appealing; it will then not be necessary to perhaps add colourants (food cosmetics) to the flesh.

In addition, the use of a starting material to which preservatives have been added will be avoided, since many preservatives, either from compounds with substances within the meat (proteins, lipids, sugars, etc.), are introduced into the food chain, or both.

Reaction products between the preservatives and the meat or the preservatives themselves may be poorly degradable in the body and/or their secretion from the body may prove difficult, something that further represents a health and environmental hazard.

According to the method of the invention, subsequently to pre-treatment of the meat with sugar, the meat is placed under a gentle vacuum in a pressure range of 330-530 mm Hg, e.g. 430 mm Hg, and is stored during a period of 7 days or more, preferably from 14 days or more, e.g. for a time interval of two to four weeks in the evacuated space. The evacuated space is preferably a refrigerated room with a temperature above 0° C., e.g. a temperature in the interval +4° C. to +8° C. The meat may during this process be placed inside a suitable container, e.g. a container of plastic, glass or metal such as aluminum, iron or steel, preferably steel. It is also possible to place the meat directly into a refrigerated room or refrigerator without any packing. This is suitable if relatively large quantities of meat are to be prepared simultaneously. The room is then placed under a vacuum within the pressure range indicated supra. Alternatively, the meat being pre-treated with sugar may be frozen over a time interval, e.g. for storage, to be later thawed and used in a thawed condition in the process according to the present invention. After a finished treatment according to the invention for producing a partially fermented product, this product may again be frozen to stop the partial fermentation process as well as for continued storage, or the meat may be used immediately after the completed partial fermentation process as a finished product for consumption. The fermentation process may also be stopped through de-pressurizing the package or adding spices to the fermented meat (also alternatively after depressurizing the package).

The temperature interval under which the meat is treated lies within the area over 0° C., e.g. 0° C.-+50° C., more preferred +2° C.-+30° C., even more preferred +2° C.-+100° C., most preferred refrigerator temperature (+2° C. -+6° C.). The fermentation process in the meat may be stopped e.g. by freezing thereof to a temperature below 0° C., preferably below −10° C., more preferably below −15° C., most preferably at freezer temperatures within the temperature interval of −20° C.-−110° C. After finished partial fermentation treatment according to the invention, the meat may also be stored at freezing temperatures over longer time periods, subsequently to be thawed at refrigerator temperatures (0° C.-+6° C.) without any disadvantage or harm.

During the time interval indicated above a partial fermentation process takes place in the pre-treated meat so that the meat, after the indicated time, has become post-treated to a partially fermented product. This post-treatment process of the pre-treated meat is unexpected and surprising since the meat is treated in advance to provide a lasting and improved product that in itself may be sold. Furthermore, it would be expected that a product being placed under vacuum would remain in its existing form, since the product has to a certain extent already been dehydrated through the sugar treatment, and besides is placed under vacuum to maintain the condition of the meat. The condition (flavour, odour, consistency) of the meat in the treated end product according to the invention depends on the choice of factors indicated above, e.g. length of time for the partial fermentation process, treatment temperature, etc. However, since the condition of the end product is also dependent on the consumers' taste, the determination of how strong and lasting the partial fermentation process should be, is determined by the individual, but a choice of the quality of the end products may easily be selected form routine tests and the knowledge of the person skilled in the art concerning the production of partially fermented meat. By keeping inside the parameters indicated above, the person skilled in the art may easily produce a product having the flavour, texture and overall condition that is desired.

Furthermore, the partial fermentation process according to the invention will depend on the size of the meat being treated, larger pieces of meat needing longer treatment time than smaller ones. Again a determination of the relevant parameters may easily be carried out by the person skilled in the art.

For supplying the meat with preferred flavour qualities, the meat may, after the partial fermentation process has been stopped, be supplied with flavour-enhancers such as spices, spice compositions, fruits, vegetables, root vegetables, as well as liquid flavour enhancers and flavour-adding substances such as essences, (e.g. cognac or whiskey essences) or beverages such as for instance port wine, red wine, cognac, whiskey, rum, etc. It is preferred that at least salt is added as a flavour additive/flavour enhancer. The choice of additive may be determined based on the flavour that is preferred for the end product and will be known for the person skilled in the art. Examples of additives may be spice such as dill, pepper, parsley, thyme, nutmeg etc., dried fruits such as raisins, figs, dates, prunes etc., or corresponding non-dried fruits, vegetables such as lettuce, tomatoes, onions, garlic, leek or paprika or root vegetables such as horseradish or carrots. Spice compositions or other flavour-adding substances may also be added such as cured gravlax dressing, mustard dressing, sour cream dressing, etc. Shrimp roe is an example of a raw product that may benefit from a flavour additive/flavour enhancer such as salt and/or spices of the type mentioned above.

The invention will be further explained with reference to some examples. These examples are to be considered as illustrative only, and are not to be construed as limiting the invention in any way.

### EXAMPLE 1

Fresh salmon halves with a thickness of about 5 cm prepared in accordance with common practice in the food industry, are placed on a grid of polyamide and their top surfaces are covered homogenously with a saccharose powder in such a way that it does not fall off (in excess). The saccharose dissolves in the meat juices and is drained away. After 36 hours of such treatment, the pieces of meat are individually placed in plastic bags of polyethylene and the bags are evacuated to a vacuum of 430 mm Hg. Each of these bags is stored for 21 days at 4° C. During this time a partial fermentation process occurs in the vacuum-stored meat, such that when the bags are opened a product is present that is ready for consumption.

### EXAMPLE 2

A piece of beef steak with a thickness of about 20 mm is covered approximately uniformly and in excess with saccharose powder. The steak is placed on a draining apparatus as disclosed in example 1, and is stored thereon for 24 hours at ambient temperature, during which time an exudates is formed that is removed by the draining apparatus and discarded. After this time, the piece of meat is placed in a plastic bag of polyethylene, whereafter the bag is placed under vacuum (430 mm Hg) and is sealed. This sealed bag is stored for a further 14 days at 4° C., during which time a partial fermentation process progresses in the meat. When opening the bag, a product is presented that is ready for consumption.

### EXAMPLE 3

A piece of beef steak with a thickness of about 20 mm is covered as in example 2 approximately uniformly and in excess with saccharose powder. The steak is placed on a draining apparatus as disclosed in example 1, and is stored thereon for 24 hours at ambient temperature during which time an exudates is formed that is removed by the draining apparatus and is discarded. After this time, a conventional amount of salt is added to the piece of meat and it is placed in a refrigerator under vacuum (430 mm Hg). The meat is stored in the refrigerator for 14 days at 4° C., during which time a partial fermentation process progresses in the meat. The fermentation process is stopped by relieving the refrigerator of the vacuum and lowering the temperature to −25° C. After this time, the piece of meat is present as a product being ready for consumption. The finished product is added dill as a flavour supplement. The piece of meat may be stored and or transported at frozen temperatures until it is to be used, and may then be thawed at +4° C. and consumed.

### EXAMPLE 4

Fresh salmon halves with a thickness of about 5 cm prepared in accordance with common practice in the food industry, are placed on a grid of polyamide and their top surfaces are covered homogenously with a saccharose powder in such a way that it does not fall off (in excess). The saccharose dissolves in the fish juices and is drained away. After 36 hours of such treatment, the pieces of fish are placed in a refrigerator on steel grids after a conventional amount of salt has been added. The refrigerator is then evacuated to a vacuum of 430 mm Hg. The pieces of fish are stored for 21 days at +4° C. During this time a partial fermentation process occurs in the vacuum-stored fish so that a product being ready for consumption is present after ended storage time. The partial fermentation process is stopped by the pieces of fish being frozen to −25° C. and the pressure returned to normal (760 mm Hg). Such pieces of fish may be placed in conventional bags and be sold as a frozen product which may be consumed after thawing at +40° C.

### EXAMPLE 5

Fresh salmon halves with a thickness of about 5 cm prepared in accordance with common practice within the food industry, are placed on a grid of polyamide and their top surfaces are covered homogenously with a saccharose powder in such a way that it does not fall off (in excess). The saccharose dissolves in the fish juices and is drained away. After 36 hours of such a treatment the pieces of fish are frozen to a temperature of about −25° C. and stored. After storage, they are again thawed at +40° C. and then warmed to ambient temperature, and the pieces of meat are placed individually in plastic bags of polyethylene which are then evacuated to a vacuum of 430 mm Hg. Each of these bags is stored for 21 days at +4° C. During this time a partial fermentation process occurs in the vacuum-stored meat so that when opening the bag there is present a product being ready for consumption.

### EXAMPLE 6

A piece of beef steak with a thickness of about 20 mm is covered approximately uniformly and in excess with saccharose powder. The piece is placed in a draining apparatus as disclosed in example 1, and is stored therein for 24 hours at ambient temperature under the forming of an exudate that is removed by the draining apparatus and is discarded. After this time the piece of meat is frozen to a temperature of −25° C. and is stored. After ended storage, the piece of meat is again thawed at +4° C. and then warmed to ambient temperature and is placed in a plastic bag of polyethylene. This bag is placed under a vacuum (430 mm Hg) and is sealed. This sealed bag is stored for further 14 days at 4° C. during which time a partial fermentation process progresses in the meat. When opening the bag there is present a product being ready for consumption.

### EXAMPLE 7

Fresh pieces of beef steak with a thickness of about 7 cm prepared in accordance with common practice in the food industry, are placed on a grid of polyamide and their upper surfaces are homogenously covered with saccharose powder so that is does not fall off (in excess). The saccharose dissolves in the meat juices and is drained off. After 48 hours of such a treatment, the pieces of meat are placed individually in plastic bags of polyethylene and the bags are evacuated to a vacuum of 430 m Hg. Each of these bags is stored for 28 days at +4° C. During this time a partial fermentation process progresses in the vacuum-stored meat such that when opening the bag, there is present a product ready for consumption.

### EXAMPLE 8

Fresh salmon halves with a thickness of about 5 cm prepared in accordance with common practice in the food industry, are placed on a grid of polyamide and their top surfaces are covered homogenously with a fructose powder in such a way that it does not fall off (in excess). The fructose dissolves in the meat juices and is drained away. After 36 hours of such treatment, the pieces of meat are individually placed in plastic bags of polyethylene and the bags are evacuated to a vacuum of 430 mm Hg. Each of these bags is stored for 21 days at 4° C. During this time a partial fermentation process occurs in the vacuum-stored meat, such that when the bags are opened a product is present that is ready for consumption.

### EXAMPLE 9

A piece of beef steak with a thickness of about 20 mm is covered approximately uniformly and in excess with fructose powder. The steak is placed on a draining apparatus as disclosed in example 1, and is stored thereon for 24 hours at ambient temperature, during which time an exudates is formed that is removed by the draining apparatus and discarded. After this time, the piece of meat is placed in a plastic bag of polyethylene, whereafter the bag is placed is under vacuum (430 mm Hg) and is sealed. This sealed bag is stored for a further 14 days at 4° C., during which time a partial fermentation process progresses in the meat. When opening the bag, a product is presented that is ready for consumption.

### EXAMPLE 10

A piece of beef steak with a thickness of about 20 mm is covered as in example 2 approximately uniformly and in excess with fructose powder. The steak is placed on a draining apparatus as disclosed in example 1, and is stored thereon for 24 hours at ambient temperature during which time an exudates is formed that is removed by the draining apparatus and is discarded. After this time, a conventional amount of salt is added to the piece of meat and it is placed in a refrigerator under vacuum (430 mm Hg). The meat is stored in the refrigerator for 14 days at 4° C., during which time a partial fermentation process progresses in the meat. After this time, the piece of meat is present as a product being ready for consumption. The partial fermentation process is stopped after the indicated treatment time by the temperature being lowered to −25° C. The piece of meat may be stored and or transported at this temperature until it is to be used, and may then be thawed at +4° C. and consumed.

### EXAMPLE 11

Fresh salmon halves with a thickness of about 5 cm prepared in accordance with common practice in the food industry, are placed on a grid of polyamide and their top surfaces are covered homogenously with a fructose powder in such a way that it does not fall off (in excess). The fructose dissolves in the fish juices and is drained away. After 36 hours of such treatment, the pieces of fish are placed in a refrigerator on steel grids after a conventional amount of salt has been added. The refrigerator is then evacuated to is a vacuum of 430 mm Hg. The pieces of fish are stored for 21 days at +4° C. During this time a partial fermentation process occurs in the vacuum-stored fish so that a product being ready for consumption is present after ended storage time. The partial fermentation process is stopped by the pieces of fish being frozen to −25° C. and the pressure returned to normal (760 mm Hg). Such pieces of fish may be placed in conventional bags and be sold as a frozen product which may be consumed after thawing at +4° C.

### EXAMPLE 12

Fresh salmon halves with a thickness of about 5 cm prepared in accordance with common practice within the food industry, are placed on a grid of polyamide and their top surfaces are covered homogenously with a fructose powder in such a way that it does not fall off (in excess). The fructose dissolves in the fish juices and is drained away. After 36 hours of such a treatment the pieces of fish are frozen to a temperature of about −25° C. and stored. After storage, they are again thawed at +40° C. and then warmed to ambient temperature, and the pieces of meat are placed individually in plastic bags of polyethylene which are then evacuated to a vacuum of 430 mm Hg. Each of these bags is stored for 21 days at +4° C. During this time a partial fermentation process occurs in the vacuum-stored meat so that when opening the bag there is present a product being ready for consumption.

### EXAMPLE 13

A piece of beef steak with a thickness of about 20 mm is covered approximately uniformly and in excess with fructose powder. The piece is placed in a draining apparatus as disclosed in example 1, and is stored therein for 24 hours at ambient temperature under the forming of an exudate that is removed by the draining apparatus and is discarded. After this time the piece of meat is frozen to a temperature of −25° C. and is stored. After ended storage, the piece of meat is again thawed at +40° C. and then warmed to ambient temperature and is placed in a plastic bag of polyethylene. This bag is placed under a vacuum (430 mm Hg) and is sealed. This sealed bag is stored for further 14 days at 4° C. during which time a partial fermentation process progresses in the meat. When opening the bag there is present a product being ready for consumption.

### EXAMPLE 14

Fresh pieces of beef steak with a thickness of about 7 cm prepared in accordance with common practice in the food industry, are placed on a grid of polyamide and their upper surfaces are homogenously covered with fructose powder so that is does not fall off (in excess). The fructose dissolves in the meat juices and is drained off. After 48 hours of such a treatment, the pieces of meat are placed individually in plastic bags of polyethylene and the bags are evacuated to a vacuum of 430 mm Hg. Each of these bags is stored for 28 days at +40° C. During this time a partial fermentation process progresses in the vacuum-stored meat such that when opening the bag, there is present a product ready for consumption.

As indicated supra the sugar treatment of the meat, especially from fish with coloured flesh, e.g. Norway haddock, char, salmon and trout, has surprisingly been found to also enhance the colour of the flesh. The treatment process comprises treating the flesh with a sugar or a sugar composition in the form of a powder, grains, a granulate or solution. A sugar in this connection encompasses a saccharide in the form of a monosaccharide, disaccharide or polysaccharide, e.g. sucrose, fructose, mannose, lactose, maltose etc. The process according to the invention produces a product with an improved nutritional value, a reduced content of harmful components such as environmentally detrimental substances and toxins, and which, during the treatment process obtains an improved or enhanced colour.

It is previously known that colour in meat originating from salmonides (salmon, trout) obtains its colour from the carotenoid astaxanthin. Astaxanthin exists naturally in algae and in the shell of crustacaeans (shrimp, crabs, lobster, crawfish etc.) and the colour in the flesh of salmonides arises naturally from the food of wild fish having eaten such organisms. Farmed fish have, however, few sources of such food available, and consequently it is common to add astaxanthin or cantaxanthin in the feed for such fish. However, it has now been discovered that large quantities of this additive may lead to poisoning of the environment so that there have been established limitations for the use of such feed material. In the market there exists on the other hand a desire to obtain meat with a stronger colour than is possible with a reduced amount of astaxanthin or cantaxanthin added in the feed. There exists consequently a need for a process wherein the colour of the meat from salmonides is enhanced after such fish have been slaughtered.

It has now surprisingly been discovered that treating the meat from such salmonides with sugar q.s. provides such an enhancement of the colour in the meat.

Additionally this treatment of the meat provides an enhancement of the solids portion (dry matter portion) and a decrease of the amount of organic acids, while it simultaneously maintains the microbial purity of the meat. Such a process comprises the meat being brought, either in a fresh, pre-treated (e.g. irradiated) or stored (frozen/tawed) condition, into contace with the sugar, preferably in the form of a powder, whereby the is formed an exudate (extract). This exudate forms an aqueous extract from the meat wherein there are extracted heavy metals, toxins, decomposition products etc. which for a large part form waste products. Such waste products may also be formed after the slaughtering of the animals where there happen in the meat several organic and biochemical reactions such as the production of acids at the entrance of rigor mortis, while the quality of the meat simultaneously will depend on the condition of the slaughter animal prior to the slaughtering (stress, feed, exercise etc.). Such reactions may produce an unpleasant taste, smell or consistency in the meat. The sugar treatment indicated supra will remove all or parts of such waste products as well as the indicated toxins and heavy metals which wind up in the exudate drawn from the meat after the sugar treatment. This exudate is discarded. A sugar treatment of the meat with saccharose is previously known and the treatment time as ell as conditions are known to the person skilled in the art. In this connection it is referred to U.S. Pat. No. 5.607.713. However, what is not known from this patent is that the meat increases its red colour by this treatment. The present invention is also directed towards the use of such a process for colouring the meat from fish with coloured meat, e.g. salmonides, especially salmon and trout.

The advantage of pre-treating the meat with sugar is that it thereby is used a process being reproducible, that does not reduce the structure of the meat, and which does not change the organoleptic properties (taste) of the meat since the exudate contains large parts of the sugar being used.

Additionally it is avoided the use that there is used a starting material containing conservatives since several conservative substances either enter into reactions with substances in the meat (proteins, lipids, sugars, etc.), are introduced into the nutritional chain or both. Reaction products between conservational substances and the meat of the conservational substances per se may be poorly degradable in the body and/or their secretion from the body may be difficult, something that furthermore represents a health and environmental risk.

The temperature interval under which the meat is processed lies in the interval above 0° C., e.g. 0° C.-+50° C., more preferred +4° C.-+30° C., even more preferred +10° C.-+28° C., most preferred room temperature (+200° C.).

Furthermore, the use of the above indicated process will depend on the size of the meat to be treated, the larger pieces of meat needing longer treatment time than small ones. Again the determination of the relevant parameters may easily be preformed by the person skilled in the art.

For providing the meat with preferred taste properties after the sugar treatment (or the vacuum treatment in the case of the partially fermented meat), the meat may, e.g. at the packaging, be added taste-enhancing materials or additives such as salt, spice, spice compositions, fruits, vegetables, roots etc. The selection of additive may be determined based on the preferred taste of the end product and will be known to the person skilled in the art. Examples of additives may be spices such as dill, parsley, thyme, nutmeg etc., dried fruits such as rasins, figs, dates, prunes etc. or corresponding non-dried fruits, vegetables such as lettuce, tomato or peppers or roots such as horseradish or carrot.

The invention will be further illuminated infra with reference to certain examples. These examples are only to be construed as illustrating and are not meant as limiting to the invention in any way.

### EXAMPLE I

Fresh salmon halves with an individual thickness of about 5 cm prepared in accordance with common practice in the food industry, are placed on a grid of aluminum and their top surfaces are covered homogenously with a saccharose powder in such a way that it does not fall off (in excess). The saccharose dissolves in the meat juices and is drained away/run off during 36 hours.

### EXAMPLE II

Fresh salmon halves with a thickness of about 5 cm prepared in accordance with common practice in the food industry, are placed lying on a grid of aluminum and the top surfaces of the fish pieces are covered homogenously with a saccharose powder in such a way that it does not fall off (in excess). The saccharose dissolves in the fish juices and is drained away/flows off during 36 hours. After the sugar treatment is finished, the salmon halves are subjected to a conventional smoking process to determine how such a process may influence the colour of the sugar-treated salmon meat. The results are given in table 1 infra.

### EXAMPLE III

Fresh salmon halves with an individual thickness of about 5 cm prepared in accordance with common practice in the food industry, are placed on a grid of polyamide and their top surfaces are covered homogenously with a saccharose powder in such a way that it does not fall off (in excess). The saccharose dissolves in the meat juices and is drained away/run off during 36 hours. After the sugar treatment is finished the salmon halves became subjected to a conventional Corning process (gravlax) to determine how such a process may affect the colour of sugar-treated salmon meat. The results are shown in Table 1 infra.

### EXAMPLE IV

Fresh cross-cut pieces of trout with an individual thickness of about 5 cm prepared in accordance with common practice in the food industry, are placed lying on a grid of polyamide and their top surfaces are covered homogenously with a saccharose powder in such a way that it does not fall off (in excess). The saccharose dissolves in the meat juices and is drained away/run off during 36 hours.

The colour of the treated fish meat pieces from example I-III are compared to the colour of an untreated piece of meat from a corresponding fish species that has its natural colour intact.

The results from these comparative tests have been summarized in a table infra wherein the following values have been used:

L-value: Describes white/black on a scale from 100 to 0 wherein 100 is completely white and has no “colour”, and 0 corresponds to completely black.

a-value: Describes red/green colour wherein (+)-values describe red colour nuances (high values have a strong red intensity), and (−)-values describe green colour nuances (wherein high values have a strong green intensity).

b-value: Describes yellow/blue colour nuances wherein (+)-values describe yellow colour nuances (high values have a strong yellow intensity), and (−)-values describe blue colour nuances (wherein high values have a strong blue intensity).

The measurements of colour tone in the pieces of meat have been conducted on the basis of an approved colour measurement wherein the measurements very closely resembles the human sense of colour. The values have the following relative connection:
L=116√(Y/Y₀)−16
a=500[√(X/X₀)−√(Y/Y₀)]
b=200[√(Y/Y₀)−√(Z/Z₀)]

wherein X₀, Y₀ and Z₀ are tristimulus values for the illumination that has been used. For the above given equations to give relevant results X/X₀, Y/Y₀ and Z/Z₀ must be larger than 0,008856.

TABLE 1

| | L-value | a-value | b-value |
|---|---|---|---|
| Ex. I | 34.40 | +11.47 | +11.02 |
| Ex. II | 37.36 | +9.19 | +13.02 |
| Ex. III | 43.71 | +8.00 | +11.78 |
| Comparative | 48.30 | +10.05 | +15.12 |

From the values of the table it is evident that all of the pieces of the treated fish meat had a deeper colour than the untreated meat. The colour tones per se concerning the red and yellow colours lie, for the meat from Ex. I, at a higher red tone intensity than untreated meat, but on a somewhat lower yellow tone intensity than for untreated meat. The meat from ex. II and III lie somewhat lower both in red and yellow intensity than untreated meat, but none of the values for the colour intensities differ significantly from the one for untreated fish meat.

The conclusion from the tests is that the treatment of the meat with sugars (monosaccharides, disaccharides, polysaccharides) enhances the colour depth of the meat, while it for a large part maintains the colour tones of the meat. The meat will appear deeper red after the sugar treatment, and less astaxanthin is needed for the red colour intensity of the meat to achieve the same colouring of the meat pieces after the sugar treatment according to the present invention.

In a third aspect the present invention concerns a process wherein meat from fish or land-dwelling animals is treated with sugar (see supra) and cured to a product with reduced harmful components (e.g. environmental poisons and toxins), and wherein the curing process proceeds faster and more expediently than in ordinary meat, while the treated meat simultaneously obtains an extended storage time on account of the drying or speed curing process.

The curing of meat is previously known from the curing of meat from land-dwelling animals such as pigs, bulls, cows, moose etc. In the conventional curing process only water is removed from the meat through evaporation after the meat has been salted, and this produces a dried product having a characteristic taste and which has improved keeping (storage) properties. However, such a product also contains its harmful substances that already existed therein originally, e.g. heavy metals, toxins, degradation products etc. that largely constitute waste substances. Such waste substances may also be produced after the slaughtering of the animals wherein the slaughtermeat is the subject of several organic and biochemical reactions, e.g. the production of acids through the intervention of rigor mortis, while the quality of the meat will simultaneously depend on the condition of the slaughtered animal prior to slaughtering (stress, feed, exercise, etc.). Such reactions may produce an inferior flavour, smell or consistency of the meat.

Also fish have previously been treated with salt and dried, e.g. klipfish. Such a product contains, however, just the same detrimental substances as indicated supra, and represent consequently a poorer product than the product produced according to the present invention.

In addition to these unfortunate properties in the previously known dried products the drying/curing process per se is conducted during a rather long time, e.g. several months.

The speed curing process according to the present invention proceeds, on the other hand, much faster (7 days—3 months, preferably 10-40 days) and represents consequently an improvement concerning the production of the product since this product then may be produced faster, with less expenses and with an improved nutritional content than the old, previously known curing method.

It exists consequently a need for a method producing a cured product without the above indicated detrimental substances, but wherein the taste of the cured product has been maintained and simultaneously wherein the storage capabilities have not been lowered, and wherein the curing process proceeds faster than what is previously known.

In a curing process according to the present invention the meat being treated with sugar is dried at a temperature above 0° C., preferably at ambient temperatures (10-25° C.), and during the period of time indicated supra. During this time water is removed from the previously sugar-desiccated meat through evaporation and leaving a cured product being ready for consumption. The instant curing process is conducted, as opposed to a partial fermentation process, through the meat not being subjected to any fermentation.

The pre-treatment of the meat being post-treated according to the invention, produces an increase of the proportion of solids (the proportion of dry matter) in the meat and a decrease of the proportion of organic acids and water-soluble acids being leached via the sugar treatment, and wherein the microbiological purity of the meat is simultaneously maintained by there not being supplied additional microbes through the pre-treatment with sugar. Such pre-treatment comprises that the meat, either in fresh, pre-treated (e.g. irradiated) or stored (frozen/thawed) condition, is brought into contact with sugar, preferably in the form of a powder, whereby an exudate is formed (extract). This exudate represents an aqueous extract from the meat wherein heavy metals, toxins, degenerative products etc. that largely represent waste products, are extracted. Such waste products may also form subsequent to the slaughtering of animals wherein the slaughtermeat is the subject of several organic and biochemical reactions, e.g. the production of acids through the intervention of rigor mortis, while the quality of the meat will simultaneously depend on the condition of the slaughtered animal prior to slaughtering (stress, feed, exercise, etc.). Such reactions may produce an inferior flavour, smell or consistency of the meat. The sugar treatment mentioned above will remove all or a part of such waste products, in addition to said toxins and heavy metals being present in the exudate from the meat subsequent to the treatment. This exudate is discarded. A specific sugar treatment of the meat with saccharose per se is known and the treatment time and treatment conditions with this sugar is known to the person skilled in the art. In this regard reference is made to U.S. Pat. No. 5.607.713. A possible time range for sugar treatment of the type of meat and meat products mentioned above, will be from 6 hours and above, e.g. for a time in the range of 6 hours to 100 hours, preferably about 24 hours. The sugar is added to the said meat in excess.

The advantage of pre-treating the meat with sugar is that a reproducible process is thereby employed that does not deteriorate the structure of the meat, and that does not change the organoleptic properties of the meat (e.g. flavour and smell) since the exudate contains a part of the sugar being used.

In addition, the use of a starting material to which preservatives have been added will be avoided, since many preservatives, either from compounds with substances within the meat (proteins, lipids, sugars, etc.), are introduced into the food chain, or both.

Reaction products between the preservatives and the meat or the preservatives themselves may be poorly degradable in the body and/or their secretion from the body may prove difficult, something that further represents a health and environmental hazard.

The process for post-treating the meat being pre-treated with sugar may be performed on any kind of meat from all types of fish, e.g. coalfish, herring, mackerel, eel, salmon, trout etc. or land-dwelling animals, e.g. pig, bull, cow, sheep, goat, moose etc., or birds, e.g. chicken, turkey, grouse, capercaillie etc. In this connection the process according to the present invention is especially suited for producing a product that may be stored over an extended period of time, contains a minimum of water and that has maintained its nutritional as well as organoleptic properties. This is advantageous for e.g. transport of meat over large distances since e.g. fish meat otherwise easily would become spoiled. When transporting such meat it is neither necessary to freeze the meat (event though a freezing process may be used), making the transport more economic and suitable than by using a transport vehicle with a freezing unit.

In the process according to the present invention the speed-curing of the meat having been pre-treated with sugar may be performed in a suitable drying room or even outdoors. The meat may also be added taste additives or enhancers such as spices, e.g. salt, pepper, garlic, onion, paprika, etc. The amounts and the types of taste enhancers or additives are known to the person skilled in the art, and correspond for a large part the amounts being used for conventionally cured meat.

That the post-treatment of the meat being pre-treated with sugars should provide an improved product is surprising in itself since the treatment with sugars is supposed to produce a lasting and improved product that in itself may be sold or consumed.

Additionally it has surprisingly been found that the speed-curing process according to the present invention proceeds equally well without any salt being added. During the above indicated time interval a speed-curing is conducted on the sugar-treated meat providing a cured product ready for consumption. This post-treatment process, being a process conducted on meat being pre-treated with sugar (see supra), may be conducted without adding any salt. This is unexpected and surprising, and so is the short curing time of this meat as compared to the common conventional curing with salt.

The character of the end product being treated according to the present invention (taste, smell, consistency) depends on the selection of the above indicated factors such as the time for the curing process, the added amount of salt, the treatment temperature, the treatment time, etc. However, since the character of the end product also is dependent on the consumer's taste, the determination of the fortitude and durance of the curing process will be up to the individual, but the determination of the quality of the end product may easily be selected based on routine tests and the knowledge of the skilled artesian concerning the production of cured meat. By keeping within the parameters indicated supra the person skilled in the art will easily be able to produce a product having the kind of taste, texture and character that is wanted.

Furthermore, the speed-curing process according to this aspect of the present invention will depend on the size of the piece of meat being treated, the bigger pieces requiring a longer treatment time than small ones. Again the determination of the actual parameters will easily be done by the person skilled in the art.

For providing the meat with preferred taste qualities, the meat may prior to or during or after the curing period, be added taste enhancers or taste additives such as spice, spice compositions, fruits, vegetables, roots, legumes, spirits, wine, beer, liquors or other fluid taste additives etc. The selection of additives may be determined based on the preferred taste of the end product, and will be known to the person skilled in the art. Examples of additives are spices such as salt, spice salts, pepper, dill, parsley, thyme, nutmeg, etc., dried fruits such as raisins, figs, dates, prunes, etc. or corresponding non-dried fruits, vegetables such as lettuce, tomato or paprika or roots such as horseradish or carrots, or dried types thereof, optionally in a combination, spirits such as cognac, whiskey, rum, aquavit, etc., wine such as madeira, port wine, red wine, white wine, strong wine, vermouth, etc., or different types of liquors etc., or combinations thereof, beer such as lager, bock, ginger or stout.

This aspect of the present invention will be further illuminated infra under reference to certain embodiments. These embodiments must not be construed as limiting for the invention, and are only to be regarded as illustrating and not in any way limiting for the invention.

### EXAMPLE a)

Fresh salmon halves prepared in accordance with common practice in the food industry, are placed on a grid of polyamide and their top surfaces are covered homogenously with a saccharose powder in such a way that it does not fall off (in excess). The saccharose dissolves in the meat juices and is drained away/run off. After 20 hours of this treatment the pieces of meat are placed in a trying room with a temperature of 20° C. and during a time period of 15-20 days, depending on the size/thickness of the pieces. After this period of time the fish meat has become dehydrated to a cured/dried product with a low water content and with a good taste. The pieces may alternatively be cut into thin slices as a salmon snack.

### EXAMPLE b)

Fresh cross-cut pieces of trout with a weight of 150 g are pre-treated with saccharose in the same manner as disclosed in example a). After removal of the accharose exudate the pieces of fish are placed in a room with a temperature of 18° C. over a period of 22 days. A product corresponding to the product in example a) is obtained.

### EXAMPLE c)

Pieces of beef with a weight of 200 g are pre-treated with saccharose in the same manner as disclosed in example a). After removal of the saccharose-containing exudate, the beef is treated for 20 days in a drying room at 22° C. The product is cured beef with an excellent taste which may be cut into thin slices as a snack.

### EXAMPLE d)

Boneless ham from pork with a weight of 2 kg is pre-treated with saccharose as indicated in example c). After removal of the saccharose-containing exudate, the ham is added a small amount of salt an treated for 30 days in a drying room at 20° C. with a good air ventilation. The product is speed-cured ham.

### EXAMPLE e)

### (Comparative Test)

Salmon halves not having been pre-treated with sugar, are placed in a drying room at the same temperature and during the same time interval as in example a). After the end of the time period the meat is still poorly dried and the curing process has barely started. This meat tastes spoiled and is not fit to be consumed. To cure such a piece of fish meat it will be required with a further drying period of several months. This meat will during such a curing period be subject to attack from bacteria and yeast making the curing of untreated fish meat a rather risky business, an the meat will most probably become more spoiled than cured.

The invention has been illuminated through non-limiting embodiments supra.

1. Process for producing a treated meat product for storage or consumption comprising pre-treating the meat with sugar in the form of grains, powder or granules to obtain an exudate and pre-treated meat, wherein this pre-treated meat optionally further is subjected to a post treatment process to produce a meat product with improved organoleptic properties.

2. Process according to claim 1, wherein the sugar is in the form of saccharose, fructose, glucose, maltose, preferably saccharose.

3. Process according to claim 1 or 2, wherein the meat having been pre-treated with sugar is placed in an airtight container being placed under vacuum with a negative pressure in the interval of 330-530 bar, whereafter the container is stored at a temperature above 0° C. for a time interval of 7 days or more, whereby the meat is subject to a partial fermentation process forming a consumable end product.

4. Process according to claim 3, wherein the meat, after ended treatment, is placed at freezing temperature.

5. Process according to claim 3 or 4, wherein a flavour additive is added to the meat at the vacuum-packing step.

6. Process according to claim 5, wherein the flavor additive is salt.

7. Process according to anyone of the claims 1-6, wherein the meat originates from a water-dwelling animal such as fresh water or salt water fish, shrimps, roe or milt.

8. Process according to claim 7, wherein the fish is salmon or trout.

9. Process according to anyone of the claims 1-6, wherein the meat originates from a land-dwelling animal.

10. Process according to claim 9, wherein the meat originates from game.

11. Process according to claim 9, wherein the meat originates from a reared animal such as sheep, cow, pig or ox.

12. Process according to anyone of the claims 1-6, wherein meat originates from birds or poultry.

13. Process according to claims 1 or 2, wherein the meat obtains an improved (darker, more brilliant) colour than the original pre-treated meat.

14. Process according to claim 13, wherein the meat originates from fish with coloured flesh.

15. Process according to claim 14, wherein the fish is salmon or trout.

16. Process according to claim 1 or 2, wherein the post-treatment is curing the sugar-treated meat.

17. Process according to any of the previous claims, wherein the treated meat is added a taste additive or taste enhancer.

18. Process according to claim 17, wherein the taste additive or enhancer is salt.

19. Process according to claim 17, wherein the taste additive or enhancer is spice or a spice composition.

20. Process according to claim 17, wherein the taste additive or taste enhancer is fruit, optionally in a dried form.

21. Process according to claim 17, wherein the taste additive or taste enhancer is a vegetable, optionally in a dried form.

22. Process according to claim 17, wherein the taste additive or taste enhancer is spirits.

23. Process according to claim 17, wherein the taste additive or taste enhancer is wine.

24. Process according to claim 17, wherein the taste additive or taste enhancer is beer.
